(19) United States
(12) Patent Application Publication
(10) Pub. No.: US 2010/0286577 A1
(43) Pub. Date: Nov. 11, 2010

(54) ROTARY MASSAGE DEVICE

(76) Inventor: Ming-Wei Tsai, Wugu Township (TW)

Correspondence Address: BIRCH STEWART KOLASCH & BIRCH, PO BOX 747, FALLS CHURCH, VA, 22040-0747, US

(21) Appl. No.: 12/435,860

(22) Filed: May 5, 2009

(51) Int. Cl. A61H 15/00

(52) U.S. Cl. 601/112

(57) ABSTRACT

A rotary massage device includes a housing in which an assembly of a worm shaft and a worm gear is operable to drive a gear plate in rotation. The gear plate includes a plurality of mounting seats of different heights for placement of a plurality of massage members thereon, wherein the massage members may have different sizes. Between the housing and the gear plate are mounted a plurality of cushion elements, which include multiple pins passing through the housing and abut against the gear plate, each pin being mounted with a spring. During operation, the actuating mechanism drives the gear plate and the massage members of different heights in rotation. Through the cushion elements, swaying movements of the gear plate can be cushioned in an effective manner, so that a user in contact with the massage members can also feel pressing and kneading massage actions.

### BACKGROUND OF THE INVENTION

1. Field of the Invention The present invention generally relates to a rotary massage device, and more particularly to a massage device capable of applying pressing and kneading massage actions.

2. The Prior Arts

Taiwanese Patent Publication Nos. 238543 and 435223 disclose a conventional massage device with an actuating mechanism that performs rotary massage actions along two circular paths. Such a mechanism uses a worm shaft that drives two opposite worm gears in opposite rotation. Accordingly, the kneading elements mounted eccentrically on the worm gears perform rotating movements along the circular paths to produce a massage action. So far, the above construction and operating movement may be disposed in the neck massage unit of a conventional massage chair or in an independent massage device. However, one of disadvantages of the aforementioned construction is that it is only able to produce a single kneading massage action, and does not have any other functions other than the massage action.

### SUMMARY OF THE INVENTION

A primary objective of the present invention to provide a massage device that can apply pressing and kneading massage actions.

Another objective of the present invention is to provide a massage device with increased functionality, capable of providing heating and vivid light effects for offering a more effective relaxing sensation to a user.

In order to achieve the objectives, an actuating mechanism provided in a massage device comprises a housing in which an assembly of a worm shaft and a worm gear is operable to drive a gear plate in rotation. The gear plate includes a plurality of mounting seats of different heights for placement of a plurality of massage members thereon, wherein the massage members may have different sizes. Between the housing and the gear plate are mounted a plurality of cushion elements, which comprise multiple pins passing through the housing and pressed against the gear plate. Each of the pins is mounted with a spring. During operation, the actuating mechanism drives the gear plate and massage members of different heights in rotation. Through the cushion elements, swaying movements of the gear plate can be cushioned in an effective manner, so that a user in contact with the massage members can also feel pressing and kneading massage actions.

In addition, a heating element is also provided on the gear plate proximate to the locations of the massage members. The heating elements can include electrically heating coils, electrically heating resistors, thermal resistors, heating lamps, etc. When powered on, the heating element produces heat that can be transferred through the massage members to a user's body for improving relaxing sensation. If the heating element is a heating lamp, in addition to heat, light can also be emitted through the massage members to provide vivid light effects, thereby improving the aesthetic aspect of the massage device.

In order to improve the massage effect, the massage members may be provided with a material with curing characteristics, such as magnetite, germanium, titanium, nano-materials, ceramics or materials that can emits infrared rays.

Owing to the placement of massage members with different heights on the gear plate, the rotation of the gear plate causes the massage members to provide a massage action comprised of rotation and up and down displacements. Two or more than two types of massage movements can be thereby achieved with a minimal amount of component parts. Furthermore, with the addition of the heating element and the material with curing characteristics in the massage members, the massage action can be combined with heating effects, promoting blood circulation and relieving fatigue.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded view showing a rotary massage device according to a first embodiment of the present invention;

FIG. 2 is a perspective view showing the rotary massage device of FIG. 1 in an assembled state;

FIG. 3 is a top view showing the rotary massage device of FIG. 1;

FIG. 4 is a cross-sectional view taken along section line IV-IV of FIG. 3;

FIG. 5 is a cross-sectional view taken along section line V-V of FIG. 3; and

FIG. 6 is a schematic view showing an operating state of the rotary massage device according to a second embodiment of the present invention.

### DETAILED DESCRIPTION OF THE PREFERRED EMBODIMENTS

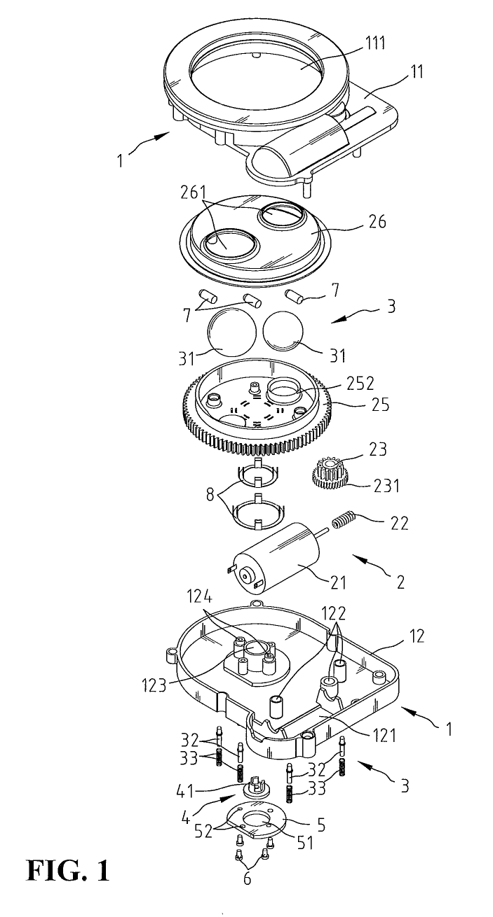

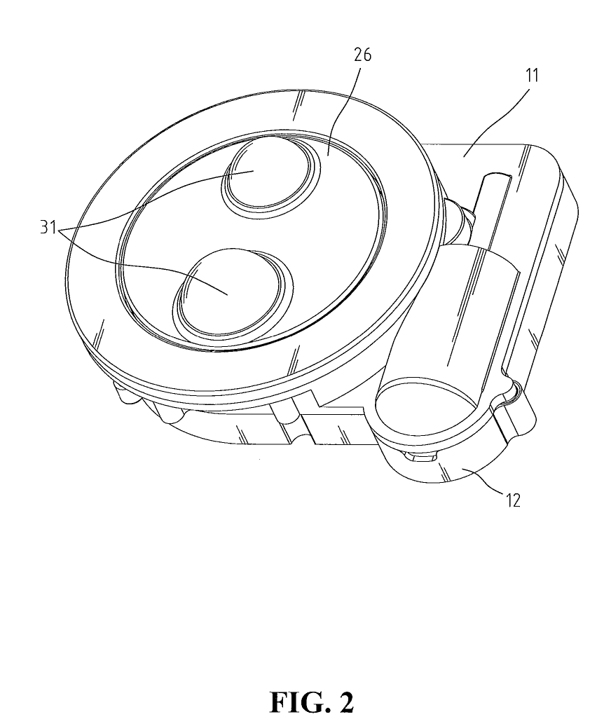

Referring to FIGS. 1 and 2, a rotary massage device according to a first embodiment of the present invention includes a housing 1 in which are mounted a power source (not shown in figures), an actuating mechanism 2 and a massage unit 3 driven by the actuating mechanism 2. The power source can be configured with a low power voltage (less than AC/DC 48V). For example, the massage device according to the present invention can operate at a power voltage of 12V.

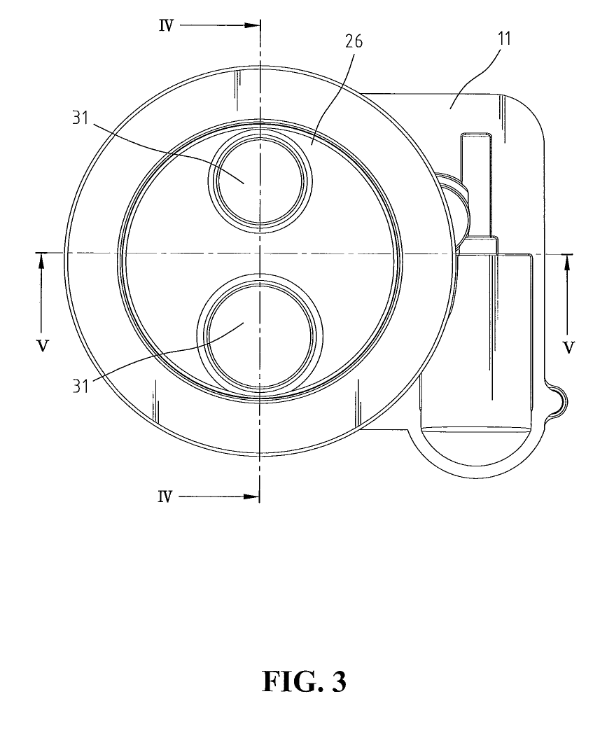

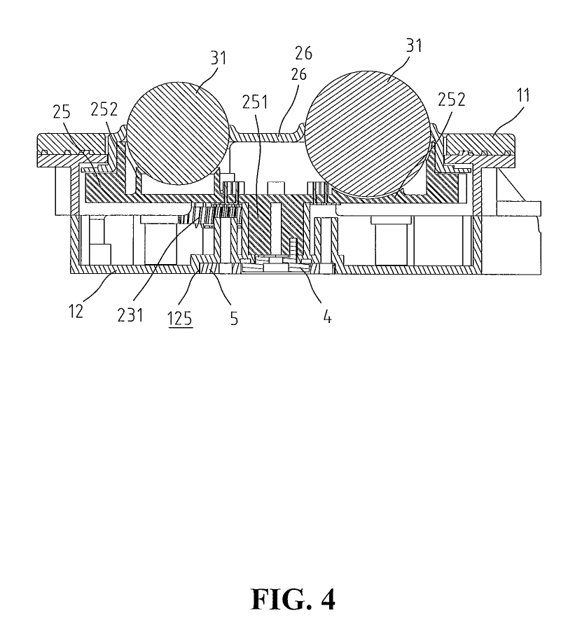

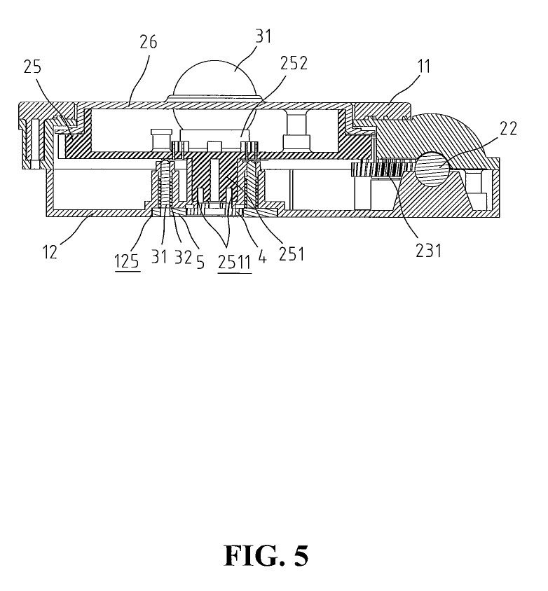

Referring to FIGS. 1-6, the housing 1 includes an upper casing 11 and a lower casing 12 that are assembled with each other to define an accommodating space for receiving the actuating mechanism 2. The upper casing 11 has a casing opening 111 allowing the massage unit 3 to protrude there through. An inside of the lower casing 12 has a motor-mounting frame 121, a plurality of connecting lugs 122 adapted to mount with the upper casing 11. In order to accommodate the actuating mechanism 2 and the massage unit 3, a main hollow column 123 and a plurality of auxiliary hollow columns 124 are provided on the lower casing 12. Further, a bottom surface of the lower casing 12 is provided with a recess 125 for placing a cleat member 4 and a stopper 5. The cleat member 4 has a circular disc and a plurality of insertion ribs 41 extended from the disc. A central area of the stopper 5 has a stopper opening 51 matching with the cleat member 4. A plurality of locking holes 52 are also defined on the stopper 5.

The actuating mechanism 2 includes a motor 21 mounted on the motor-mounting frame 121. A rotary axle of the motor 21 is connected with a worm shaft 22 that engages with a worm gear 23. The worm gear 23 includes a larger gear 231 in engagement with outer teeth of a gear plate 25. A bottom surface of the gear plate 25 is provided with a connecting boss 251 having a diameter smaller than that of the main hollow column 123. The connecting boss 251 includes a plurality of holes 2511 that the amount of the holes 2511 is equal to that of the insertion ribs 41 of the cleat member 4. A top of the gear plate 25 also includes a plurality of mounting seats 252 of different heights.

The massage unit 3 comprises a plurality of massage members 31 slidably assembled on the mounting seats 252, and a plurality of cushion elements. The massage members 31 may not be limited to any specific constructions. The structure of the massage members 31 includes, but not limited to, a raised shape with a curved surface or with non-uniformly angled surface portions (not shown). According to the first embodiment, the massage members 31 may be formed as massage balls of different sizes and made of a transparent material or a translucent material, such as glass. The massage balls may be made of a various material, such as plastics, metal and ceramics. Sandalwood, Agilawood or wood having aroma may also be used to form the massage members 31. Such wood have the advantage of dissipating aromatic scent or Phytoncide. Based on alternative medicine, the massage members 31 may be made of materials with curing characteristics, such as magnetite, germanium, titanium, nano-materials or materials that can emits infrared rays, to alleviate muscle pain and enhance blood circulation. The massage members 31 may also be made of a material containing the aforementioned ingredients. A user may desirably select or change the massage members based on their different shapes or constituent materials. The cushion elements include a plurality of pins 32 each mounted with a spring 33. Each set of pin 32 and spring 33 is mounted in one of the auxiliary hollow columns 124, the pin 32 passing through a top of the auxiliary hollow column 124. The connecting boss 251 on the bottom surface of the gear plate 25 is inserted in the main hollow column 123. The insertion ribs 41 of the cleat member 4 are fitted into the corresponding holes 2511 of the connecting boss 251. The circular disc of the cleat member 4 is pressed against the recess 125. The gear plate 25 and the lower casing 12 are thereby mounted with each other. The stopper 5 is disposed in the recess 125 to cover the cushion elements in the auxiliary hollow columns 124, and is securely fixed on the bottom surface of the lower casing 12 through locking elements 6. Thus, the gear plate 25 is located above the auxiliary hollow columns 124 and supported by the pins 32. A cover 26 is also provided to cover the gear plate 25. The cover 26 includes a plurality of restricting openings 261 adapted to restrict the massage members 31 and prevent the massage members 31 from dropping out of the gear plate 25. The casing opening 111 of the upper casing 11 is adapted to receive the cover 26. When the upper casing 11 is mounted on the lower casing 12, the cover 26 is located at the position of the casing opening 111, and the massage members 31 protrude through the casing opening 111, as shown in FIG. 2.

In addition to the massage elements, a heating element 7 is also provided on the gear plate 25 at a location proximate to the massage members 31. The bottom surface of the gear plate 25 is mounted with a plurality of electrically conductive rings 8 made of metal. The rings 8 are connected with the power source through connecting wires (not shown). The heat produced by the heating element 7 is transferred to the massage members 31. The heating element 7 can be thermally-dissipating resistors, thermal resistors, ceramic heaters, or filaments, lamps, etc. According to the first embodiment, the heating element 7 includes heating lamps.

According to the present invention, the power source of the massage device is configured with a lower power voltage design, which provides a safer operating configuration than conventional massage devices having a high power voltage (greater than 48V). When the massage device is powered on, the motor 21 drives the worm shaft 22, the worm shaft 22 drives the worm gear 23 and the worm gear 23 drives the gear plate 25 to rotate. Because the insertion ribs 41 of the cleat member 4 is fitted in the holes 2511 of the connecting boss 251 of the gear plate 25, the cleat member 4 accordingly rotates along with the gear plate 25 within the stopper opening 51 of the stopper 5, without affecting the rotation of the gear plate 25. When the gear plate 25 is rotating, the pins 32 mounted with the springs 33 act as cushions to balance and cushion the swaying movement of the gear plate 25.

The massage members 31 in the gear plate 25 not only rotate along with the gear plate 25, but also spin on themselves on the mounting seats 252. If the heating element 7 (heating lamps in the present embodiment) is also activated, the massage members 31 also dissipate heat and emit light while applying massage action. The light thereby emits through the massage members 31 and gear plate 25, hence providing a vivid light effects.

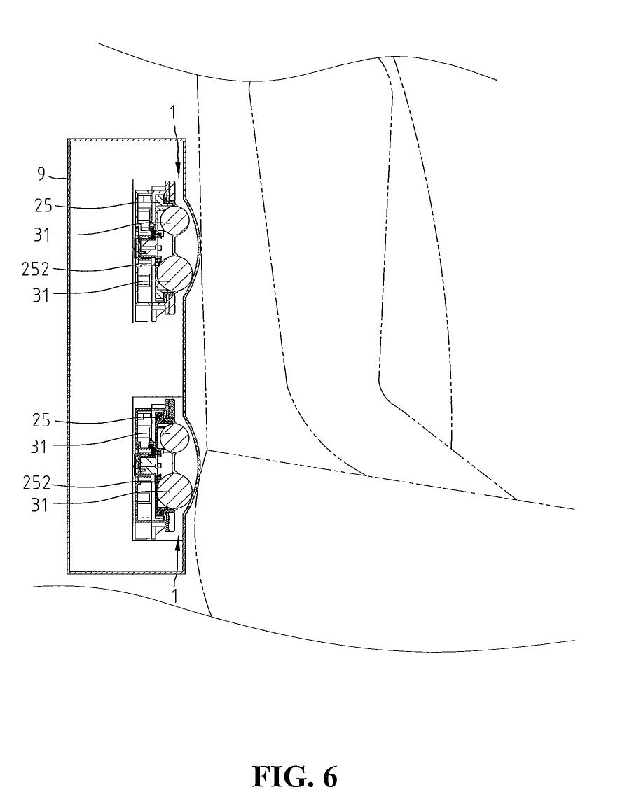

FIG. 6 is a schematic view showing an operating configuration of the massage device according to a second embodiment of the present invention. Because the massage mechanism is enclosed inside the housing 1 as a module, several of the modules can be enclosed in an outer housing 9, a case, a box, an encapsulating device or a backrest for forming a massage device. The massage device according to the present invention may be used for massaging any regions of a user's body. In the second embodiment, the massage device is used for back massage. When the user's back contacts with the massage members 31 driven to rotate by the gear plate 25, the user will feel alternatively acupressure massage actions from the massage members 31 caused by the difference in height of the each mounting seat 252 and the difference in size of the each massage member 31. Owing to the combination of the intermittent pressing and self-spinning movements of the massage members 31 applied on the user's back, the user can feel a comfortable kneading massage action. Moreover, in addition to the massage actions, the user can also feel heating and the other curing effects described above provided by the characteristics of the material making up the massage members 31, which enhances blood circulation and relieve fatigue.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A rotary massage device, comprising:
an upper casing and a lower casing assembled together to form an accommodating space, the upper casing having an casing opening;
a power source disposed in the accommodating space;
an actuating mechanism including a motor for driving a set of gears, the set of gears driving a gear plate provided with a plurality of mounting seats of different heights, the actuating mechanism being mounted on the lower casing and electrically connected with the power source;
a massage unit including a plurality of massage members and cushion elements, wherein the massage members are disposed on the mounting seats corresponding to the casing opening of the upper casing, the cushion elements are mounted between the lower casing and the gear plate so as to abut against the gear plate;
wherein the actuating mechanism drives the gear plate and the massage members of different heights in rotation, and the cushion elements are operable to balance and cushion a swaying movement produced by the gear plate, whereby the massage members produce pressing and kneading massage actions on a region of a user's body in contact therewith.

2. The massage device according to claim 1, further comprising a plurality of heating elements disposed proximate to the massage members on the gear plate, wherein the heating elements are electrically connected with the power source.

3. The massage device according to claim 2, wherein the heating elements are one of lamps, electrically heating coils, electrically heating resistors and thermal resistors.

4. The massage device according to claim 1, wherein the gear plate and a cover are matched with each other, the massage members and the heating elements are disposed between the gear plate and cover, and the cover includes a plurality of restricting openings for restricting the placement of the massage members.

5. The massage device according to claim 2, wherein the gear plate and a cover are matched with each other, the massage members and the heating elements are disposed between the gear plate and cover, and the cover includes a plurality of restricting openings for restricting the placement of the massage members.

6. The massage device according to claim 1, wherein the massage member includes a material with curing characteristics.

7. The massage device according to claim 1, wherein the massage member is made of a material with curing characteristics.

8. The massage device according to claim 6, wherein the material with curing characteristics includes magnetite, germanium and titanium.

9. The massage device according to claim 7, wherein the material with curing characteristics includes magnetite, germanium and titanium.

10. The massage device according to claim 1, wherein the cushion elements comprise a plurality of pins that pass through the lower casing and abut against the gear plate, and each of the pins is mounted with a spring.
